(19) United States
(12) Patent Application Publication
(10) Pub. No.: US 2003/0152230 A1
(43) Pub. Date: Aug. 14, 2003

(54) System and method for secure communication and storage of information

(76) Inventor: Cynthia Gayle Eaker, Summerville, SC (US)

Correspondence Address: Cynthia Gayle Eaker, 167 Braly Drive, Summerville, SC, 29485, US

(21) Appl. No.: 10/073,565

(22) Filed: Feb. 11, 2002

(51) Int. Cl. H04L 9/00

(52) U.S. Cl. 380/255

(57) ABSTRACT

A system and method for ultra-secure communication and or storage of information by encryption comprising the steps of: (a) providing one or more electronic devices at one or more locations with each electronic device having: (i) memory; (ii) a processor; (iii) at least one unpredictable sequence of numbers available from memory while encryption and decryption is being performed. (iv) at least one software program that employs a unique property of prime numbers to determine the numbers used from number sequences in memory used in character transformation and or transposition; (b) providing secure communication between electronic devices; (c) providing secure storage of digitized information on electronic devices; (d) selecting random numbers and control characters that vary for encrypted messages sent to all electronic devices and are unknown to one or more electronic devices receiving the message prior to decoding it with the numbers and control characters used to code being mixed into the message itself before transmission or storage occurs; and (e) comprising a coded message that must be decoded by using a correct key and correct software program from myriad possible keys and many possible programs that locates and uses the random numbers and control characters interspersed within the coded message to decode the message they were mixed into.

### BACKGROUND

1. Field of Invention

This invention relates to a system and method for secure communication and storage of information, specifically to an improved system and method that is ultra-secure and easy to use.

2. Description of Prior Art

Encryption has been used to communicate privately for hundreds of years. The encryption systems and methods that now do so are numerous. But there is only one method known to be perfect in that it cannot be broken if used properly. The One Time Pad by Vernam in July 1919, U.S. Pat. No. 1,310,719, is perfect in its ability to securely encrypt communication but to the same degree it is also impractical. This is because it requires the sender and receiver to have identical sets of random key pads that are as long and numerous as the messages being sent. The number of pads needed for sustained communications and the problem of securely distributing those pads is considerable. The perfect system is perfectly impractical.

### OBJECTS AND ADVANTAGES

My above patent uses a practically endless number of unique digit sequences that are generated from a large fixed number of digits determined by a key. This results in a practical, ultra-secure, encryption system. It generates unpredictable digit sequences using a unique property of prime numbers. If a prime number of random digits are arranged in a ring the number of unique, unpredictable, digit sequences that can be made from it approaches that prime number squared. Each unique digit sequence made has the length of that prime number. The number of unique digit sequences is further increased by effective transposition of the digits and or summing multiple sequences together without carries.

In my system and method a multitude of unique digit sequences created using this method are used to change plaintext into ciphertext. The ciphertext is also well shuffled in over 10\hat{ }150 ways using non-repeating digit sequences determined by the key and system and method used. The resulting coded messages consist of an unbroken string of 100 possible ciphertext characters that appear random in distribution until decoding shows that they are not.

Messages may be any information that can be digitized and transmitted by many means including, but not limited to, light signals, electromagnetic signals, audio signals, telephony networks, visual images, wired and wireless cable, satellite transmission, cellular phone signals, or computer networks. Accordingly, several objects and advantages of the present invention are:

(a) to provide an encryption system that forces codebreakers to resort to brute force attacks on the key used to code messages even though its length approaches 10\hat{ }8,000 factorial.

(b) to provide elegant coded messages made up of an unbroken string of 100 unique coded characters that have no more than 5,010 ciphertext characters for every 5,000 characters of plaintext.

(c) to provide a coded message that will sometimes have fewer coded characters than the uncoded ones it came from by coding plaintext prior to encryption.

(d) To provide an ultra-secure encryption system and method that is easy to use.

(e) To provide an encryption method that can be set to automatically code and decode information to and from one or more senders with one or more keys.

(f) To provide a symmetric or asymmetric encryption system.

(g) to provide an encryption system and method that will be backward compatible and grow stronger as future versions increase the number of system and methods available to code messages with the system and method used to code messages always being indeterminable from examination of ciphertext.

(h) to provide an encryption system and method that will be easy to modify when the source code is made public allowing users to easily make their own unique mutation that is ultra-secure.

(i) to provide an encryption method that intersperses vital decoding information into the ciphertext.

(j) to provide an encryption method that uses numerous system and methods to code messages and intersperses the system and method information used in coding into the ciphertext.

(k) to provide an encryption system that thoroughly shuffles ciphertext characters after first breaking them into one or more components resulting in a very fine and complex rearrangement.

(l) to provide an encryption system that provides users computer-end security by intentionally corrupting, shuffling, and or removing vital digit arrangements used to code and decode.

(m) to provide an asymmetric encryption system that makes it statistically impossible to use identical digit sequences in the transformation phase of coding messages for up to 100 years.

(n) to provide an encryption system employing a large number of unique, unpredictable, digit sequences derived from skipping through a large prime number of digits in a ring at different starting points with skip sizes that vary which are then used to convert plaintext to ciphertext.

(o) to provide an encryption system that automatically corrects some of the negative effects of poor key choices and allows users to choose short or long keys.

(p) to provide an encryption system that has an easy to use parallel key making procedure resulting in a private key made publicly.

(q) to provide an encryption system that converts a key into unique digit sequences and a unique prime string of digits to code information.

(r) to provide an encryption system that can be used to easily generate random digit sequences.

Further objects and advantages of my invention will become apparent from a consideration of the ensuing explanation and detailed description.

### SUMMARY, RAMIFICATIONS, AND SCOPE

Accordingly, the reader will see that the encryption system and method of this invention can be used to easily code and decode information for secure storage and or transmission to self, individuals, or groups whether the information is in the form of text audio, or images using ultra-secure encryption.

Cryptanalysts will find no shortcut to decoding ciphertext without knowing the key since frequency analysis on coded messages will yield no helpful clues. Frequency analysis will also become increasingly difficult since the system and method used to code any message is indeterminable and more systems and methods will be released over time. A brute force attack to determine the key will be necessary but equally futile. This is because the key size may easily approach 10\hat{ }8,000 factorial which is far larger than that thought necessary to provide security for hundreds, if not thousands, of years.

Users of the encryption system and method will appreciate that it is unbreakable for all practical purposes and that they have the flexibility of being able to choose short or long keys from plaintext or ciphertext that can themselves be coded for end security. They will also appreciate the ability to easily create a secure private key through an exchange of information on transmission lines known to be insecure.

Readers will appreciate the value of communications being automatically coded and decoded once a key is made. Recognizing that encrypted communications should be the norm just as it is the norm for private messages to be sent in sealed envelopes instead of being sent written on postcards.

I claim:

1. In an encryption system and method of the type using character transformation and transposition accomplished in myriad ways determined by a key, that is chosen by the user, which determines how said transposition is performed and also determines what characters are transformed into by the use of a digit ring having a prime number of digits which are determined by said key and yields a multitude of unique digit sequences by a variable starting point and variable skip size on said digit ring to harvest digits from said ring to effect said transformation, the improvement whereby said encryption system and method produces ciphertext that varies when a message is coded even if said message is coded many times with the same key.

2. The encryption system and method of claim 1 wherein said ciphertext produced is always an unbroken string of 100 possible characters without spaces or returns in no recognizable order and having characters that vary each time a message is coded even if said message is coded many times with the same key.

3. The encryption system and method of claim 1 wherein character transformation is accomplished by message digits being summed with digits determined by said key using addition without carries.

4. The encryption system and method of claim 1 wherein said transposition is accomplished by the transformed digit string being reordered to match the order of a sequence of digits that do not repeat and are determined by said key.

5. The encryption system and method of claim 1 wherein information is automatically coded and decoded using appropriate keys once communication has been established.

6. The encryption system and method of claim 1 wherein two numbers are chosen at random to determine said staring position on said digit ring and said skip size around said digit ring to harvest digits for said character transformation

7. The encryption system and method of claim 1 wherein said key made from a small amount of text is used to make a multitude of unique digit sequences composed of unique numbers that do not repeat that are used to shuffle digits to achieve said transposition and said key is also expanded to make a large prime string of digits that is relatively random and used as said digit ring to harvest digits used in said transformation.

8. The encryption system and method of claim 1 wherein the variable digits that determine said staring point on said digit ring and said skip size around said digit ring and the variable digits used in said transformation and transposition are mixed into the digit sequence that becomes ciphertext.

9. The encryption system and method of claim 1 wherein the system and method used to code the message is determined by at least one cipher character that is mixed into the ciphertext.

10. The encryption system and method of claim 1, further including enhanced end user security by corrupting and or removing unique number sequences determined by said key when said encryption system and method is not in use.

11. The encryption system and method of claim 1, further including a system and method variation that makes said encryption system and method asymmetric by using the number of seconds elapsed since the year began and digits that vary in the year positions to determine start and skip numbers making repetition of digit sequences used for character transformation statistically impossible for up to 100 years using said system and method variation.

12. The encryption system and method of claim 1, further including a variation of the system and method that replaces character patterns often seen in plaintext messages with a smaller unique character sequence before the standard encryption process resulting in compression of the ciphertext.

13. The encryption system and method of claim 1, further including a variation of the system and method that codes and decodes audio and digital information.

14. The encryption system and method of claim 1, further including a variation using a high quality random number generator used to generate the digits for said start and said skip numbers and other random numbers used in said encryption system and method.

15. The encryption system and method of claim 1, further including a variation with said start and said skip numbers that are not determined at random but by the number of seconds that have elapsed since the new year began accurate to a fraction of a second and summed using standard addition with numbers from digits found in the unique digit sequences determined by said key.

16. The encryption system and method of claim 1, further including a variation that makes the digit sequences used in said transformation more unpredictable by summing it without carries with a digit sequence made by other digits harvested from said digit ring before it is used to effect character transformation.

17. The encryption system and method of claim 1, further including a variation that relies upon high quality transformation that renders transposition unnecessary for encryption strength.

18. The encryption system and method of claim 1, further including a variation of the system and method that provides means for coding of coded messages by first converting all cipher characters into characters that are valid for coding.

19. The encryption system and method of claim 1, further including a variation that uses random numbers generated from at least one source not from said encryption system and method to code information.
